(19) United States
(12) Patent Application Publication
(10) Pub. No.: US 2014/0245944 A1
(43) Pub. Date: Sep. 4, 2014

(54) LOCKABLE MOUNTING SYSTEM

(71) Applicant: TACIT GOLF LLP, Warwickshire (GB)

(72) Inventor: Timothy Elliot WEBB, Warwickshire (GB)

(73) Assignee: TACIT GOLF LLP, Warwickshire (GB)

(21) Appl. No.: 13/783,636

(22) Filed: Mar. 4, 2013

(51) Int. Cl. G09F 17/00

(52) U.S. Cl. CPC G09F 17/00
USPC 116/173

(57) ABSTRACT

A lockable mounting system comprising a cylindrical mount having a pair of radially extending flanges and a tubular collar with a cooperatively shaped recess located on an inner surface to engage with the flanges of the mount. In use, the collar is inserted over the mount such that that the recess is able to pass over the flanges when they are rotationally aligned. The collar is prevented from becoming detached from the mount when the recess and flanges are rotationally misaligned.

### FIELD OF THE INVENTION

The present invention relates to a lockable mounting system that may be used without a nut or additional fixing means for rotatably mounting a collar on a mount, and in particular to a system that allows a flag to be mounted on, and to rotate freely around a flag pole without the risk of detachment in adverse weather conditions.

### BACKGROUND TO THE INVENTION

Flags or banners are usually mounted on top of a flag pole to display information to a user, or to indicate the position of a fixed location. The information presented is not limited to, but may typically indicate the direction and force of the wind, a warning, a direction or series of directions or even a simple advertisement for products or services. Flags are also frequently encountered in a variety of sporting games or activities, often to indicate the territory or field position that a team has established, or to highlight that an offence that has been committed by an individual or a team. In the game of golf for example, a flag is used to indicate the hole or pin position that a golfer may be aiming for.

A typical method of mounting golf flags onto flag poles involves the attachment of the housing comprising the flag, onto a cylindrical flag pole. The housing is typically slotted over the top of the flag pole and then secured to the flag pole by standard connection means such as a cooperatively shaped nut or screw. This can often be a time consuming task which requires the use of a special tool to release the nut or screw from the end of the flag pole in order to remove the flag from the pole.

It would be advantageous to have a system which enables a user, such as a green keeper in the game of golf, to be able to attach or remove a flag from a flag pole with ease. It would be particularly advantageous if the method of securing the flag to the flag pole still permitted the flag to rotate freely around the flag pole, without the flag becoming wrapped around either itself or the flag pole. It would also be highly advantageous if the flag was able to rotate freely around the flag pole without the risk of the flag becoming detached from the flag pole, when it is not intended to be released. It would also be advantageous if the means to secure the flag, or the flag housing, to the flag pole did not require the use of a special tool to be able to complete the task.

### SUMMARY OF THE INVENTION

Accordingly, the present invention provides apparatus for rotatably mounting a collar on a mount, the apparatus comprising a collar, a mount and a golf flag pole, wherein: the mount comprises a first end portion having at least one radially extending flange, a second end and a cylindrical mounting portion formed between the first end portion and the second end, the mount further comprising means for mounting the mount on the golf flag pole;
the collar has a height that is equal to, or less, than an axial length of the cylindrical mounting portion and has a cylindrical inner surface that is sized to substantially conform to an outer surface of the cylindrical mounting portion and to allow the collar to be freely rotatably mounted thereon; and
the collar has at least one recess formed in its inner surface, the at least one recess, the at least one radially extending flange and the first end portion being shaped and dimensioned to allow the collar to completely pass over the first end portion of the mount when the at least one recess is rotationally aligned with the at least one flange but to prevent the collar passing over the first end portion of the mount when the at least one recess and the at least one flange are rotationally misaligned.

The apparatus allows a collar to be rotatably mounted on a mount, and for the collar to be securely connected to the mount by a locking/connection means that may be used without a nut or additional fixing means. In an embodiment of the invention, the locking/connection means may comprise the at least one flange positioned on the first end portion, which may be received by the at least one recess formed in the inner surface of the collar. The collar may only be mounted on or removed from the mount when the at least one recess and at least one flange are rotationally aligned. All other variations in rotation of the collar around the mount cause the at least one recess and the at least one flange to be rotationally misaligned. When misaligned in this manner, the collar cannot therefore be attached to or removed from the mount. The invention therefore allows the simple connection of collar to mount by a user, but prevents the inadvertent removal of the collar from the mount. Additional help from a user would be required for this to occur.

The mount may be constructed from any suitable material, for example a metal, or a thermoplastic material, such as polytetrafluoroethylene (PTFE). Preferably the material is durable and resistant to prolonged exposure to damp or wet weather conditions, if it is to be used in an external environment. The collar may also be constructed from any suitable rigid material. Preferably the material is durable and again will withstand exposure to the elements, for example a thermoplastic material such as PTFE.

The apparatus may comprise the first end portion having only one flange, and it is envisaged that in alternative embodiments of the invention, the first end portion may comprise a plurality of flanges. The first end portion may have at least two flanges which are circumferentially offset by a distance at least equal to a thickness of the collar to ensure that the collar is unable to become detached from the mount. However, it is more unlikely that the collar will become detached from the mount when the flanges are radially spaced as far apart from each other as possible. In the embodiment when two flanges are present on the first end portion, the flanges may be offset from each other by as little as a few degrees, although if they are offset by the maximum of 180° this will provide the most secure attachment of the collar to the mount. In embodiments of the invention when there are a plurality of flanges, it will be anticipated that a preferred arrangement will be when the flanges are spaced as far apart from each other. For example, when three flanges are present on the first end portion, the flanges will ideally be spaced at 120° intervals.

In embodiments of the invention, the mount may further comprise an additional cylindrical mounting portion formed at an outer end of the first end portion, with an additional end portion formed at an outer end of the additional cylindrical mounting portion. The additional end portion may have at least one radially extending flange. In embodiments of the invention, the additional end portion may have at least two flanges which are circumferentially offset by a distance at least equal to a thickness of the collar. In these embodiments of the invention, the end portion, the mounting portion and the flanges of the additional end portion are sized and dimensioned to cooperate with the at least one recess of the collar in the same manner as previously described.

In a similar manner, it will equally be anticipated that the flanges on a first end portion and on an additional end portion may be separated axially by any distance to ensure that the collar is unable to become detached from the mount. The minimum distance of separation will correspond to the axial height of the collar in order to allow the collar to rotate freely around the unthreaded portion of the cylindrical mounting portion. It will be appreciated that as the axial distance between the flanges increases, the chances of the collar becoming detached from the mount will significantly decrease.

It will be appreciated by a person skilled in the art that there are no limits to the number of additional cylindrical mounting portions, and hence radially extending flanges, which may be formed at an outer end of the first end portion. A preferred embodiment of the invention comprises a mount having two cylindrical mounting portions, each cylindrical mounting portion having a single radially extending flange which are significantly offset from each other. The purpose of a lockable mounting system comprising an additional, or a plurality of, extra cylindrical mounting portions is to provide an enhanced connection means for the collar to the mount. With an increase in the number of flanges and/or additional mounting portions that the collar must pass over in order to become attached to the mount, there is a decrease in the likelihood that the collar will become detached of its own volition. It is anticipated that the only way for the collar to become detached from the mount unaided would be for a gust of wind to propel the collar up the mount, and to simultaneously rotate the collar in order to align the recess with the flanges permitting its removal. It is believed that this situation will almost certainly never occur, and the provision of the additional cylindrical mounting portions will limit the chance of the collar rotating and aligning with several flanges to zero.

The lockable mounting system is also preferably configured to comprise additional mounting means located at or near the second end of the mount in order to attach the mount to a flag pole. For example, the mount may have an aperture in the base of the mount that may be fixed to a flag pole. The flag pole may be a golf flag pole used in the game of golf. It will also be appreciated that under some circumstances, alternative embodiments of the invention provide that the lockable mounting system is integrally formed at the end of a flag pole. Again, the flag pole may be a golf flag pole. In use, the lockable mounting system may additionally comprise a flag or banner that is attached to, or integrally formed with, the collar to display information to a user. On such an occasion, it is anticipated that a tubular support may extend from the base of what would ordinarily be termed a collar in order to support or provide further mounting means for a flag or banner.

In embodiments of the invention, the lockable mounting system comprises a shoulder integrally formed to support the collar, for example when the lockable mounting system is formed at the top of a pole. In this embodiment, the shoulder is integrally formed with the pole and is located at a position along the length of the pole in order to support the collar when it is attached to the mount. The shoulder preferably will surround the body of the mount completely in a continuous fashion through 360°. The collar can be received by the mount with the body of the pole inserted through the collar, until the collar contacts and is supported by the shoulder.

In embodiments of the invention, the shoulder can be formed at the second end of the mount and again will most preferably will surround the body of the mount completely in a continuous fashion through 360°. A shoulder formed in this way permits the collar to contact and be supported by the shoulder. It is anticipated for any embodiment where a shoulder is present that the shoulder may also be formed in a variety of other embodiments, such as for example, a plurality of discrete flanged unit portions projecting radially outwards from the body of the mount.

The invention as described above solves the problems of providing a lockable mounting system for allowing a flag to be mounted on a flag pole, and for the process to be carried out quickly and efficiently. In particular, the lockable mounting system permits a flag to mounted onto a flag pole so that the flag is still able to rotate unhindered around the flag pole, but without the risk of the flag becoming detached from the flag pole in adverse weather conditions. A flag that is attached to the collar of the invention is free to rotate around the cylindrical mounting portion of the mount. It is anticipated that the only way for the collar to become detached from the mount unaided would be for a gust of wind to propel the collar up the mount, and to simultaneously rotate the collar in order to align the recess with the flanges permitting its removal. It is believed that this situation will almost certainly never occur, and the provision of the additional cylindrical mounting portions will limit the chance of the collar rotating and aligning with several flanges to zero. The lockable mounting system described above also has the advantage that no special tools or keys are required in order to mount, replace or remove a flag from a flag pole when the system is implemented.

Specific embodiments of the invention are now described by way of example and with reference to the accompanying drawings in which like numerals are used to indicate like parts.

### DRAWINGS

FIG. 1 is a top view of the collar component of the lockable mounting system;

FIG. 2 is a side view of the mount component of the lockable mounting system; and

FIG. 3 is a side view of a lockable mounting system incorporating a flag, which is mounted on top of a flag pole.

### DETAILED DESCRIPTION

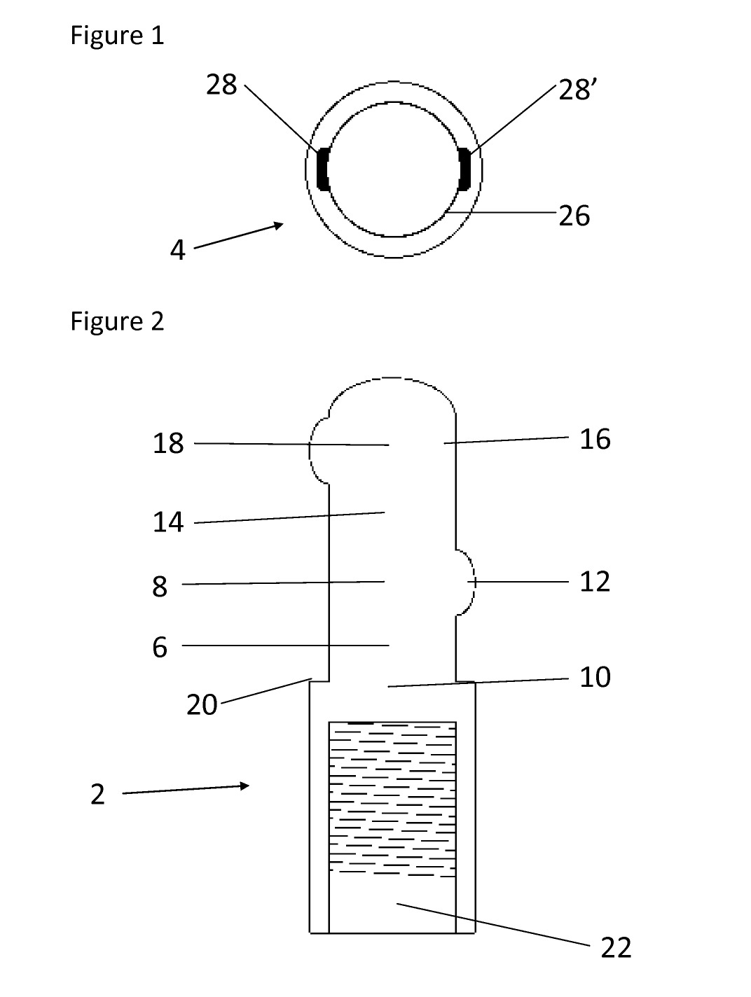

Referring now to the drawings, FIGS. 1 and 2 show the component parts of the apparatus comprising the lockable mounting system, as described in more detail below.

The lockable mounting system comprises a cylindrical mount 2 and a tubular collar 4. The mount 2 is constructed from the thermoplastic material polytetrafluoroethylene (PTFE). FIG. 2, shows the mount 2 having a cylindrical mounting portion 6 which is formed between a first end portion 8 and a second end 10. The first end portion 8 has a radially extending flange 12 located on an outer surface of the first end portion 8. The flange 12 is located on a surface of the first end portion 8. The mount further comprises an additional cylindrical mounting portion 14 formed at an outer end of the first end portion 8, with an additional end portion 16 formed at an outer end of the additional cylindrical mounting portion 14. The additional end portion 16 further has a radially extending flange 18 located on an outer surface.

In this particular example, FIG. 2 illustrates the mount 2 having a shoulder portion 20 formed at the second end 10 of the mount 2. The cylindrical mounting portion 6 is generally smooth or unthreaded to allow the collar 4 to rotate freely and unhindered around the mount 2. The mount 2 also comprises additional fixing or securing means 22, in particular a threaded blind bore in an aperture of the mount 2, in order to attach the mount 2 to a standard flag pole 24.

The collar 4 is also constructed from the thermoplastic material PTFE. The tubular collar 4 has a cylindrical inner surface 26 that is sized to substantially conform to the outer mounting surface of the cylindrical mounting portion 6 which allows the collar 4 to be freely rotatably mounted on the mount 2. The collar 4 has an axial height that is equal to, or less, than the axial length of the cylindrical mounting portion 6 in order to permit this to happen. The collar 4 has an inner surface 26 with two recesses 28, 28′ located in the inner surface 26 which are shaped and dimensioned to cooperatively engage with the flanges 12, 18 of the mount 2, and to allow the collar 4 to pass over the additional end portion 16 and the first end portion 8 when the recesses 28, 28′ are rotationally aligned with the respective flanges 12, 18 thereof. The collar 4 is therefore prevented from passing over the first end portion 6 and additional end portion 16, when the recesses 28, 28′ and flanges 12, 18 are rotationally misaligned. Although the flanges 12, 18 may take on a variety of sizes of dimensions, and the recesses 28, 28′ in the collar 4 are shaped and dimensioned so that the collar 4 may pass over the cooperatively formed flanges 12, 18, it will be appreciated that the flanges 12, 18 embodied as simple protrusions will suffice in order to allow the invention to function. It will also be appreciated that although FIG. 1 shows an embodiment of the invention where the collar 4 has a two recesses 28, 28′ formed in an inner surface 26, it will be evident that the number of recesses 28, 28′ in the collar 4 is not limited, but may comprise one recess or even a e.g. a plurality of recesses. The number of correspondingly shaped and dimensioned flanges 12, 18 may therefore be varied in order to provide suitable locking means for the collar 4 and the mount 2.

The lockable mounting system 1 is operated as follows with regards the embodiment as illustrated in FIGS. 1 and 2. The collar 4 is mounted or inserted on top of the mount 2 with the inner surface 26 of the collar 4 receiving the mount 2. The flange 18 located at the additional end portion 16 of the mount 2 is aligned with and passes through the either of the recesses 28, 28′ in the inner surface 26 of the collar 4. The collar 4 is then rotated, in either a clockwise or counter-clockwise direction, until the flange 12 on the first end portion 8 is aligned with either of the recesses 28, 28′ at which point the flange 12 is able to pass through the recess 28, 28′ in the inner surface 26. Upon passing through the recess 28, 28′ the collar 4 may optionally be rotated, in either a clockwise or counter-clockwise direction, in order to misalign the flanges 12, 18 with the recesses 28, 28′. The collar 4 is able to pass further along the cylindrical mounting portion 6 of the mount 2 until it contacts and is in abutment with the shoulder portion 20 at the second end 10. The shoulder portion 20 prevents the collar 4 from passing further along the cylindrical mounting portion 6 of the mount 2, yet still permits the collar 4 to rotate freely around the cylindrical mounting portion 6 of the mount 2.

In use, the collar 4 is supported by the shoulder 20 and is able to freely rotate around the mount 2. The collar 4 is prevented from becoming detached from the mount 2 due to the presence and location of the two flanges 12, 18 on the cylindrical mounting portion 6 and additional cylindrical mounting portions 14, without additional help from a user. In order to detach the collar 4 from the mount 2, a user would have to reverse the operating instructions as follows.

The collar 4 that is at rest against the shoulder 20 is rotated until the either of the recesses 28, 28′ in the collar 4 are in alignment with the flange 12 of the first end portion 8 so that the recess 28, 28′ may pass over the flange 12. After the flange 12 has cleared the recess 28, 28′, the collar 4 is rotated again in order to align the recess 28, 28′ with the flange 18 on the additional end portion 16. The recess 28, 28′ is then permitted to pass over the flange 18, such that the collar 4 no longer remains in lockable engagement with the mount 2. The collar 4 can therefore be removed from the mount 2 by sliding the remains of the collar 4 over the additional end portion 16 of the mount 2.

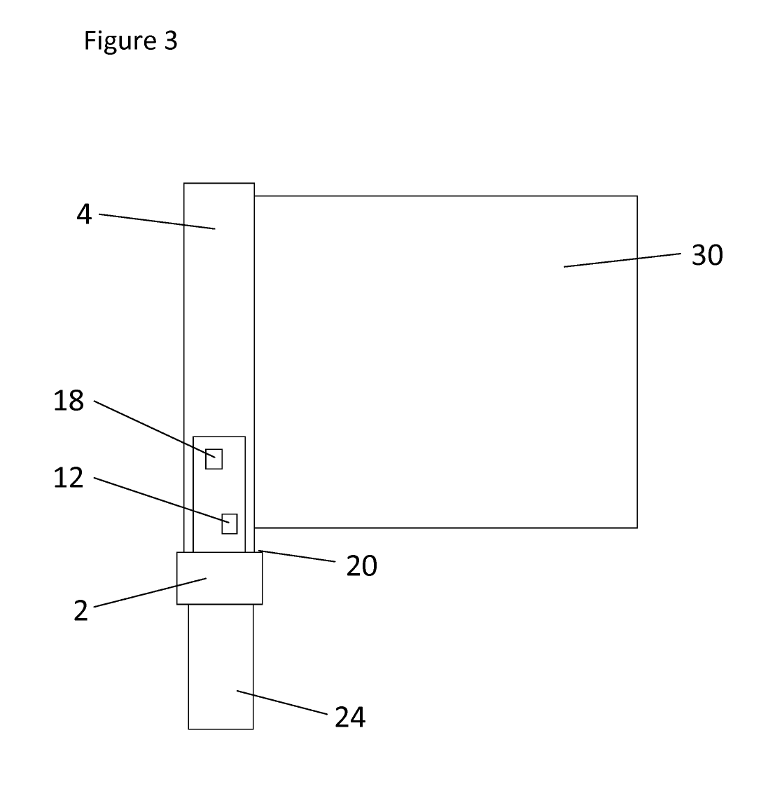

It will be appreciated by a person skilled in the art that the lockable mounting system can be attached or located on the end of a flag pole 24. The mount 2 has securing/attachment means 22, in particular a blind threaded bore, in order to securely fasten the lockable mounting system to the top of a cooperatively threaded flag pole 24, as can be seen in FIG. 3. In FIG. 3, the collar 4 comprises a flag or banner 30.

In the embodiment of the invention illustrated by FIG. 3, when the lockable mounting system is integrally formed at the end of a pole 24, the pole 24 comprises an integrally formed shoulder 20 at a position along the axis of the pole 24, rather than at the second end 10 of the mount 2. The collar 4 further comprises a tubular support extending away from the base of the collar 4 in order to support or provide further mounting means for a flag or banner 30, and is attached to the mount 2 in the manner as previously described. On this occasion, when the recess 20 in the collar 4 has passed over the second flange 14, the collar 4 is able to pass over the mount 2 until it contacts and is in abutment with the shoulder portion 16 located at a position on the pole 24. The shoulder portion 16 on the pole 24 prevents the collar 4 from passing further along the length of the pole 24, yet still permits the collar 4 to rotate freely around the cylindrical mounting portion 8 of the mount 2.

1. An apparatus for rotatably mounting a collar on a mount, the apparatus comprising a collar, a mount and a golf flag pole, wherein:
the mount comprises a first end portion having at least one radially extending flange, a second end and a cylindrical mounting portion formed between the first end portion and the second end, the mount further comprising means for mounting the mount on the golf flag pole;
the collar has a height that is equal to, or less, than an axial length of the cylindrical mounting portion and has a cylindrical inner surface that is sized to substantially conform to an outer surface of the cylindrical mounting portion and to allow the collar to be freely rotatably mounted thereon; and
the collar has at least one recess formed in its inner surface, the at least one recess, the at least one radially extending flange and the first end portion being shaped and dimensioned to allow the collar to completely pass over the first end portion of the mount when the at least one recess is rotationally aligned with the at least one flange but to prevent the collar passing over the first end portion of the mount when the at least one recess and the at least one flange are rotationally misaligned.

2. The apparatus according to claim 1, wherein the first end portion has a plurality of radially extending flanges.

3. The apparatus according to claim 1, wherein at least two flanges are circumferentially offset by a distance at least equal to a thickness of the collar.

4. The apparatus according to claim 1, wherein the mount further comprises:
an additional cylindrical mounting portion formed at an outer end of the first end portion; and
an additional end portion formed at an outer end of the additional cylindrical mounting portion, wherein the additional end portion has at least one radially extending flange.

5. The apparatus according to claim 4, wherein the additional end portion has a plurality of radially extending flanges.

6. The apparatus according to claim 4, wherein at least two flanges are circumferentially offset by a distance at least equal to a thickness of the collar.

7. The apparatus according to claim 1, wherein the golf flag pole comprises an integrally formed shoulder for supporting the collar.

8. The apparatus according to claim 1, wherein a shoulder for supporting the collar is formed at the second end of the mount.

9. The apparatus according to claim 8, wherein the shoulder portion surrounds the body of the mount in a continuous fashion.

10. The apparatus according to claim 1, wherein a flag or banner is attached to the collar.

11. An apparatus for rotatably mounting a collar on a mount, the apparatus comprising a collar, a mount and a golf flag pole, wherein:
the mount comprises a first end portion having at least one radially extending flange, a second end and a cylindrical mounting portion formed between the first end portion and the second end, the mount being integrally formed at the end of the golf flag pole;
the collar has a height that is equal to, or less, than an axial length of the cylindrical mounting portion and has a cylindrical inner surface that is sized to substantially conform to an outer surface of the cylindrical mounting portion and to allow the collar to be freely rotatably mounted thereon; and
the collar has at least one recess formed in its inner surface, the at least one recess, the at least one radially extending flange and the first end portion being shaped and dimensioned to allow the collar to completely pass over the first end portion of the mount when the at least one recess is rotationally aligned with the at least one flange but to prevent the collar passing over the first end portion of the mount when the at least one recess and the at least one flange are rotationally misaligned.

12. The apparatus according to claim 11, wherein the first end portion has a plurality of radially extending flanges.

13. The apparatus according to claim 11, wherein at least two flanges are circumferentially offset by a distance at least equal to a thickness of the collar.

14. The apparatus according to claim 11, wherein the mount further comprises:
an additional cylindrical mounting portion formed at an outer end of the first end portion; and
an additional end portion formed at an outer end of the additional cylindrical mounting portion, wherein the additional end portion has at least one radially extending flange.

15. The apparatus according to claim 14, wherein the additional end portion has a plurality of radially extending flanges.

16. The apparatus according to claim 14, wherein at least two flanges are circumferentially offset by a distance at least equal to a thickness of the collar.

17. The apparatus according to claim 11, wherein the golf flag pole comprises an integrally formed shoulder for supporting the collar.

18. The apparatus according to claim 11, wherein a shoulder for supporting the collar is formed at the second end of the mount.

19. The apparatus according to claim 18, wherein the shoulder portion surrounds the body of the mount in a continuous fashion.

20. The apparatus according to claim 11, wherein a flag or banner is attached to the collar.
